(19) United States
(12) Patent Application Publication
(10) Pub. No.: US 2008/0236005 A1
(43) Pub. Date: Oct. 2, 2008

(54) Menu board assembly

(76) Inventors: Igor Isayev, Berkley, MI (US); David U. Hillstrom, Hancock, MI (US)

Correspondence Address: HARNESS, DICKEY & PIERCE, P.L.C., P.O. BOX 828, BLOOMFIELD HILLS, MI, 48303, US

(21) Appl. No.: 11/728,436

(22) Filed: Mar. 26, 2007

(51) Int. Cl. G09F 13/04

(52) U.S. Cl. 40/574

(57) ABSTRACT

An illuminated display device includes a cabinet containing at least one illumination lamp and at least first and second sides. Each of the sides includes a first door rotatably connected to the cabinet, and a second door rotatably connected to the cabinet and sharing a common rotation axis with the first door. The second door is positioned between the first door and the illumination lamp when both the first and second doors are oriented in a door closed position. A door frame of the second door has opposed frame members each including incrementally spaced slots positioned as opposed pairs of slots. The slots releasably receive divider members, proximate ones of the divider members being adapted to releasably retain a sign insert. The sign insert is illuminated by the lamp and is visible through the first door in the door closed position.

### FIELD

The present disclosure relates to illuminated display devices and a method for displaying graphic information of a device type having interior cabinet lighting and backlit graphic indicia.

### BACKGROUND

The statements in this section merely provide background information related to the present disclosure and may not constitute prior art.

Illuminated outdoor signs and display devices are commonly used for presenting advertising and point of purchase information. For example, fast-food restaurants use signs on their premises adjacent pathways leading to the restaurant or along their vehicle drive-through service lanes. These devices are used to display various menu items and/or to provide information and prices for consumers. In addition, “specials” are often promoted by these devices. These signs are often lighted for enhanced viewing, either in the front by spot light, flood lights or overhead lighting, or more often from the back through translucent panels. The advent of both breakfast and dinner menus in fast-food restaurants militated against changing the inserts or indicia of a single faced outdoor sign for each menu change. Double faced outdoor signs have therefore been developed, however, known double faced signs have limitations.

These signs must be readily adjustable to accommodate a wide variety and size of graphic indicia. To this end the viewable area is divided into narrow sections by support members that are releasably fastened or otherwise secured to the sign. The support members capture the top and bottom edges of the graphic indicia and hold it in place. While signs of this design adequately support narrow menu strip type graphics, larger graphics tend to bend or bow and thus distort the displayed image, therefore limiting the maximum size of the graphics display. Furthermore, the ability to support multiple sized graphics using a support system that permits rapid and easy change to different sizes and quantities of graphics is a further limitation of known sign designs. These variables can affect the overall quality and appearance of the displayed information.

When used outdoors, sign displays of this type must also be able to withstand the above noted environmental conditions, such as wind, rain, snow, sun, freezing temperatures and elevated temperatures, and still maintain their integrity and usefulness for their intended purposes. With enclosed housings and with transparent members covering and protecting the display indicia, condensation and moisture can adversely affect the display. In addition, enclosed, backlit signs experience relatively high internal temperatures due to the heat generated by the lights as well as heat load caused by the sun (i.e.: solar gain) on the display. Such extreme internal conditions can significantly impair the viewability of the sign and the displayed information and even warp and destroy the display indicia, particularly display indicia of a styrene material commonly used for its reduced cost and good illumination properties.

Accordingly, there is a need in the art to provide an improved sign display which may be readily adapted to accommodate graphic indicia of various shapes and sizes, particularly larger sized pictorial graphics. The sign display should also be sufficient robust to withstand the adverse operating conditions of wind, precipitation and temperature extremes.

### SUMMARY

According to additional embodiments of a menu board assembly of the present disclosure, an illuminated display device includes a housing having at least one illumination lamp positioned in the housing, and at least one face. The at least one face includes an outer first door rotatably connected to the housing, the first door having a substantially clear or transparent panel; and an inner second door rotatably connected to the housing and positioned between the first door and the illumination lamp in a door closed position. The second door is adapted to releasably hold a sign or other graphic indicia back-illuminated by the lamp and visible through the clear panel.

According to further embodiments, an illuminated display device includes a cabinet containing at least one illumination lamp and at least first and second sides. Each of the sides includes a first door rotatably connected to the cabinet, and a second door rotatably connected to the cabinet and sharing a common rotation axis with the first door. The second door is positioned between the first door and the illumination lamp when both the first and second doors are oriented in a door closed position. A door frame of the second door has opposed frame members each including incrementally spaced slots positioned as opposed pairs of slots. The slots releasably receive divider members, proximate ones of the divider members being adapted to releasably retain a sign insert. The sign insert is illuminated by the lamp and is visible through the first door in the door closed position.

According to still further embodiments, a menu board illuminated display device includes a cabinet containing at least one illumination lamp, and having at least first and second sides. Each of the sides includes a hinge connected to the cabinet; a first door rotatably connected to the cabinet using the hinge; and a second door rotatably connected by the hinge to the cabinet and sharing a common axis of rotation with the first door, the second door positioned between the first door and the illumination lamp when both the first and second doors are oriented in a door closed position.

According to still further embodiments, a menu board illuminated display device includes at least one fan connected to a cabinet that is operable to draw atmospheric air into the cabinet to create a positive air pressure at least between first and second doors mounted to the cabinet.

According to still additional embodiments, a method is provided for displaying sign inserts with an illuminated display device.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front perspective view of a menu board assembly of the present disclosure;

FIG. 2 is a rear perspective view of the menu board assembly of FIG. 1;

FIG. 3 is a front perspective view similar to FIG. 1 showing a first side outermost located first door in a partially open position and a second door in a closed position;

FIG. 4 is a front perspective view similar to FIG. 2 showing a second side outermost located first door in a partially open position and a second side second door in a closed position;

FIG. 5 is a side elevational view of the menu board of FIG. 1;

FIG. 6 is a front elevational view of the menu board assembly of FIG. 1 having the first side first and second doors removed to identify an interior cabinet arrangement;

FIG. 7 is a rear perspective view having the second side first and second doors removed;

FIG. 8 is a cross sectional plan view looking down, with the first side first and second doors installed, taken at section 8 of FIG. 6;

FIG. 9 is a cross sectional elevational view, with the first side first and second doors installed, taken at section 9 of FIG. 6;

FIG. 10 is a cross sectional plan view looking down, with the first side first and second doors installed, taken at section 10 of FIG. 6;

FIG. 11 is partial cross sectional elevational view, with the first side first and second doors installed, taken at section 11 of FIG. 6;

FIG. 12 is a partial perspective view of an exemplary configuration of multiple divider members connected to the second door frame;

FIG. 12A is an end perspective view of an exemplary one of the divider members of the present disclosure;

FIG. 13 is a perspective view of a three sided menu board assembly embodiment of the present disclosure;

FIG. 14 is a partial cross sectional diagrammatic plan view through a central area of the menu board of FIG. 13, having the doors removed and the outer facing sides of the cabinet represented in line format for clarity;

FIG. 15 is a diagrammatic view of air flow paths through a two-sided menu board assembly of the present disclosure; and

FIG. 16 is a cross sectional plan view taken at area 16 of FIG. 8 showing additional details of display device 10.

### DETAILED DESCRIPTION

The following description is merely exemplary in nature and is not intended to limit the present disclosure, application, or uses. It should be understood that throughout the drawings, corresponding reference numerals indicate like or corresponding parts and features.

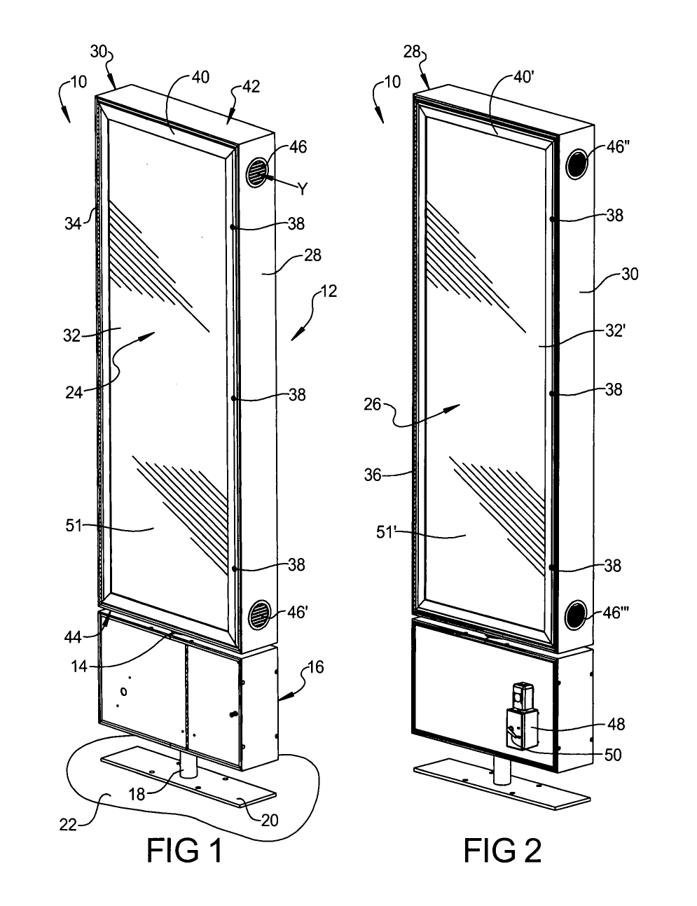

Referring in general to FIGS. 1 and 2, a display device 10 of the present disclosure can include a housing or cabinet 12 which in accordance with several embodiments has a rectangular shape. Cabinet 12 is rotatable by a support post 14 which is rotatably driven by a mechanical device such as an electric motor positioned within a mechanism cabinet 16. Mechanism cabinet 16 is itself non-rotatably supported to a ground or support surface using a fixed post 18 and a support plate 20. Fasteners (not shown) can be inserted through support plate 20 to anchor mechanism cabinet 16 to a foundation 22 in the ground.

Cabinet 12 includes a first display side 24 shown in greater detail in FIG. 1, a second display side 26 oppositely positioned from first display side 24 and shown more clearly in FIG. 2. Cabinet 12 also includes a first cabinet side or wall 28 shown in greater detail in FIG. 1, and a second cabinet side or wall 30 positioned opposite to first wall 28 and shown in greater detail in FIG. 2. An outwardly facing first door 32 is provided on first display side 24 which is rotatably supported to cabinet 12 by a first hinge 34. As shown in FIG. 2, a second hinge 36 is diagonally positioned on an opposing corner of cabinet 12 from first hinge 34 and rotatably supports a first door 32′ of second display side 26. First and second doors 32, 32′ can be substantially identical to each other.

A plurality of fasteners such as quarter turn fasteners 38 are insertable through each of first door 32 and first door 32′ to releasably engage first doors 32, 32′ to structure of cabinet 12 in a door closed position. FIG. 1 identifies a first door frame 40 of first door 32 rotatably connected to first hinge 34 and FIG. 2 identifies a first door frame 40′ of first door 32′ rotatably connected to second hinge 36. Cabinet 12 further includes an upper wall 42 and a lower wall 44 (not clearly visible in these views).

To provide a source of cooling air to an internal cavity of cabinet 12, as seen in FIG. 1 a plurality of air intake ports identified as air intake port 46 and air intake port 46′ are provided in first wall 28. Similarly, as seen in FIG. 2, a pair of air intake ports 46″ and 46′″ are provided in second wall 30. The total number of air intake ports can vary at the discretion of the manufacturer. As more clearly visible in FIG. 2, mechanism cabinet 16 can also include an electrical junction box 48 providing for an electrical power connection into cabinet 12. A power switch 50 can also be provided to energize or de-energize display device 10. For example, display device 10 can be de-energized using power switch 50 for local maintenance work such as bulb replacement or to insert or change display signs therein. It is noted that each of the air intake ports 46, 46′, 46″, 46′″ are configured to only receive intake air in a cabinet air flow inlet direction “Y”. Each of the first doors 32, 32′ includes a first door viewing pane or panel 51, 51′ respectively, each according to several embodiments provided from a clear or substantially transparent material such as glass or a polymeric material substitute for glass.

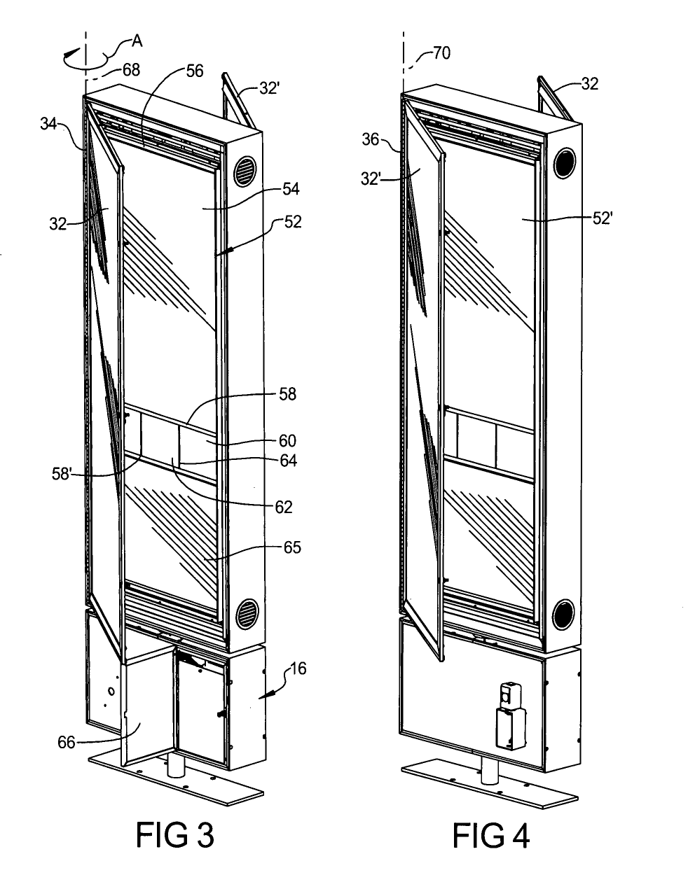

Referring now to FIG. 3, first door 32 is shown in a partially open position. It is noted that first door 32 rotates at first hinge 34 from the closed position shown in FIG. 1 to a fully open position which can vary in degrees of rotation defined by a counter-clockwise door rotation arc “A” up to approximately 180 degrees of rotation. First door 32 is released from the closed position shown in FIG. 1 by rotating fasteners 38 to disengage fasteners 38. A second door 52 is positioned on a cabinet inward facing side of first door 32 and is also rotatably connected to first hinge 34. Through their common connection to first hinge 34, first door 32 and second door 52 can co-rotate about first hinge 34, or first and second doors 32, 52 can be independently rotated with respect to each other.

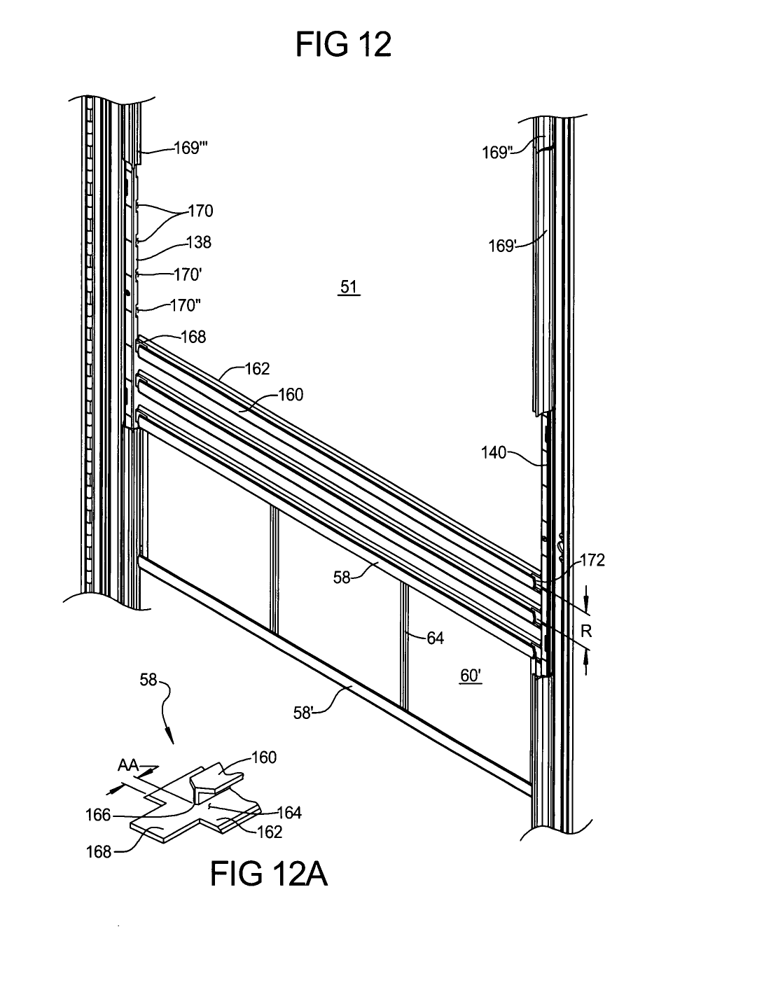

Second door 52 includes a light diffusing second door panel 54 which according to several embodiments is provided of a translucent or semi-transparent material capable of diffusing light from a light source positioned within cabinet 12 to be subsequently discussed herein. Second door panel 54 is supported within a second door frame 56 of second door 52. A plurality of divider members 58 can be releasably engaged with vertical opposed frame members of second door frame 56 at pre-determined increments which will be described in greater detail in reference to FIG. 12. An exemplary arrangement has a first sign insert 60 and a second sign insert 62 supported between divider members 58, 58′. One or more completely opaque vertical divider lines 64 can be used to distinguish sections or portions of individual inserts. A larger sign insert 65 can also be supported by second door frame 56 by appropriate spacing of one or more divider members 58. Each of the sign inserts 60, 62, 65 is supported on an outward facing side of second door panel 54. This permits the light generated within cabinet 12 to diffuse through second door panel 54 and backlight each of the sign inserts.

First door panel 51 is therefore made of a clear or substantially transparent material so the sign inserts supported within cabinet 12 and backlit by light diffused through second door panel 54 are visible by an observer outside of cabinet 12. An access door 66 can be provided in mechanism cabinet 16 for access to a drive mechanism positioned therein. As viewed in FIG. 3, the first door 32 and second door 52 are rotatable using first hinge 34 about a door axis of rotation 68 defined through first hinge 34.

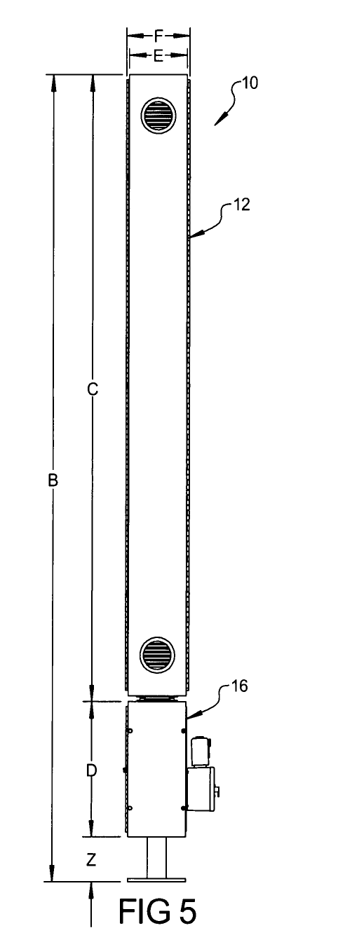

Referring now to FIG. 4, first door 32′ is similarly rotatable about second hinge 36 to provide access to second door 52′. Similar to first and second doors 32, 52, both first door 32′ and second door 52′ are rotatable individually or together using second hinge 36 about a door axis of rotation 70 defined by second hinge 36. First door 32′ and second door 52′ are substantially identical to each of first door 32 and second door 52, respectively. The use of a double-sided cabinet, each side having a two-door configuration for display device 10, allows for a given side to be provided with a first theme of sign inserts which can be, for example, representative of a breakfast meal assortment. At the same time, a second theme such as a lunch or dinner menu for the sign inserts on the opposite side can be provided by display device 10. The second theme can then be observed by rotating cabinet 12 one hundred eighty degrees.

As best seen in reference to FIG. 5, display device 10 has a total assembly height “B”, and cabinet 12 has a cabinet height “C”. Mechanism cabinet 16 has a mechanism cabinet height “D” and mechanism cabinet 16 is supported above the ground surface providing a ground clearance dimension “Z”. Both cabinet 12 and mechanism cabinet 16 can both include a cabinet wall depth “E” and a cabinet total depth “F”. According to several embodiments of the present disclosure, total assembly height “B” can be approximately 82.7 inches (210 cm), cabinet height “C” can be approximately 63.5 inches (161.3 cm), and mechanism cabinet height “D” can be approximately 14 inches (35.6 cm). In several embodiments, cabinet wall depth “E” is approximately 6 inches (15.25 cm), and cabinet total depth “F” can be approximately 6.6 inches (16.8 cm). Ground clearance dimension “Z” can be approximately 4.3 inches (10.9 cm). The above dimensions are provided as examples only. The present disclosure is not limited by these dimensions as they can vary at the discretion of the manufacturer.

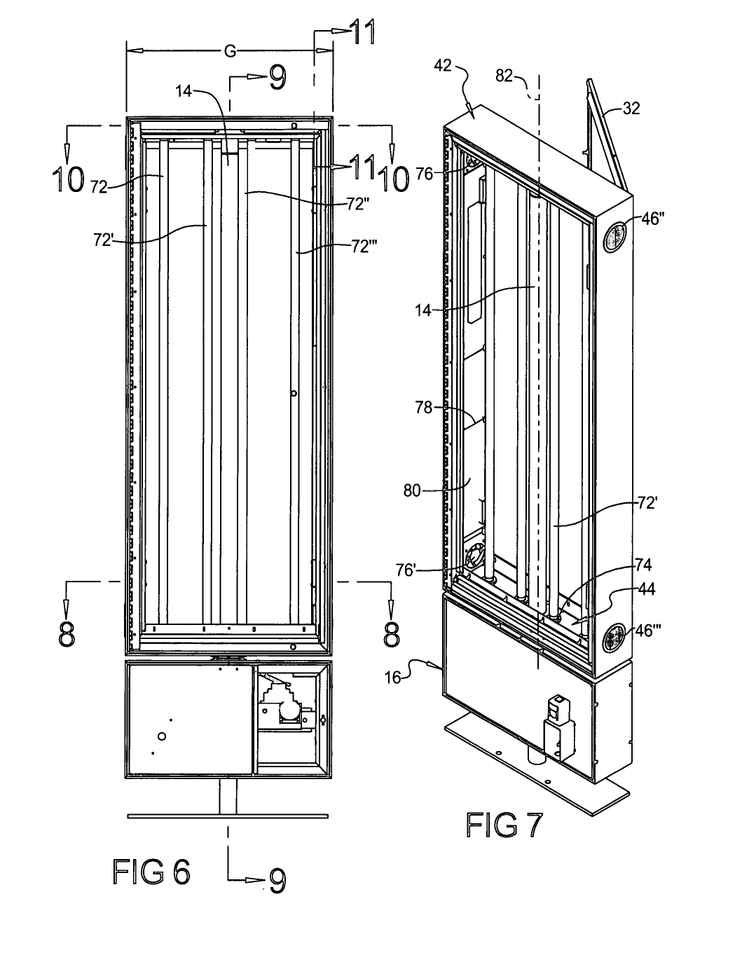

Referring now to FIG. 6, both first door 32 and second door 52 are removed for clarity. A plurality of bulbs 72 are vertically configured within the envelope of cabinet 12. According to several embodiments four bulbs 72 are used which are identified as bulb 72, 72′, 72″ and 72′″. Bulbs 72 can be, for example, fluorescent or similar bulbs. Also shown in FIG. 6, support post 14 extends axially throughout substantially the total height of cabinet 12 to provide rigidity to cabinet 12 and resistance to wind load. According to several embodiments, a cabinet width “G” can be approximately 24.8 inches (63 cm).

Referring now to FIG. 7, a socket 74 is provided at each end of each of the bulbs 72 for mechanical as well as electrical contact. Sockets 74 are therefore positioned proximate to each of the upper wall 42 and lower wall 44. A fan is mounted proximate to each of the intake ports 46, and in this example a fan 76 and a fan 76′ are shown. Corresponding fans 76″ and 76′″ (not visible in this view) are also positioned proximate to each of the intake ports 46″ and 46′″. Fans 76 rotate to provide a suction draw of atmospheric air from outside of cabinet 12 to the inner compartment of cabinet 12 where cooling is provided for the heat generated by each of bulbs 72, as well as from the heat load from ambient air or from solar gain. Display device 10 only provides suction ports for drawing ambient air into cabinet 12, which therefore creates a net positive air pressure within cabinet 12 when each of the first and second doors 32, 32′ and 52, 52′ respectively are in their closed positions.

No exhaust ports similar to air intake ports 46 are provided in cabinet 12. The air which is drawn in by fans 76 is instead forced out through small gaps associated with each of the first and second doors 32, 32′ and 52, 52′ to maintain the net positive air pressure within cabinet 12. The inner second doors 52, 52′ are vertically shorter than both the cabinet 12 and the outer first doors 32, 32′. A space or gap is therefore created between the cabinet upper wall 42 and the top of both second doors 52, 52′. The outer first doors 32, 32′ are each shorter than a height of the door opening provided in cabinet 12 and this height differential creates a gap which is selectively located at the bottom of first doors 32, 32′. When the first and second doors 32, 32′ and 52, 52′ are in their respective door closed positions, a seal is provided between the vertical side frame members of first doors 32, 32′ and corresponding frame members of second door 52, 52′, and also between the upper horizontal frame member of first doors 32, 32′ and cabinet 12. The seals limit out-flowing air volume to less than the inflowing air volume capable of being generated by fans 76, and therefore a net positive air pressure is created inside cabinet 12 when fans 76 are operating.

This positive air pressure inside cabinet 12 forces air that is drawn into cabinet 12 by fans 76 to circulate within an open space 77 and then to flow into the gap at the top of second doors 52, 52′, downward through the space or gap between corresponding first and second doors (for example between first door panel 51 and second door panel 54), and then out the gap defined between the bottom of the outer first doors 32, 32′ and cabinet 12. Air that is drawn into cabinet 12 by fans 76 circulates within open space 77 and is forced into the above noted air flow gaps by the pressure differential between open space 77 and the ambient pressure outside of cabinet 12 for discharge from cabinet 12. The positive air pressure maintained in cabinet 12 provides for a fully mixed flow within cabinet 12 which promotes substantially even cooling of the various components. The positive internal cabinet air pressure also maintains a consistent air flow between first and second doors 32, 52 or 32′, 52′ to maintain a cooling flow over the sign inserts connected to second doors 52, 52′ when fans 76 are operating.

As also seen in FIG. 7, cabinet 12 provides an aperture 78 created at a free end of a panel or pocket 80 positioned for example against first wall 28. One purpose for aperture 78 and pocket 80 is to provide a storage area for unused ones of divider members 58 as well as an extra amount of divider members 58 so multiple ones of the divider members 58 are locally available to suit multiple configurations of sign inserts. As further shown in FIG. 7, cabinet 12 rotates with respect to mechanism cabinet 16 about a cabinet axis of rotation 82 defined by support post 14. Cabinet 12 can rotate in a repeating increment of 180 degrees or can be free to rotate about a full 360 degree arc.

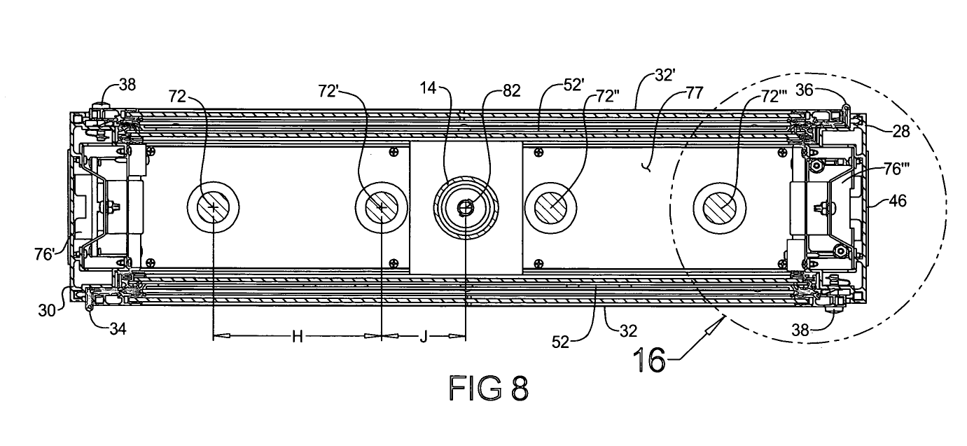

Referring now to FIG. 8, the individual spacing of bulbs 72 is identified. Spacing between any two proximate bulbs 72 is defined by a bulb separation distance “H”. Each of bulbs 72′ and 72″ are spaced at a bulb clearance dimension “J” from cabinet axis of rotation 82 defined by support post 14. According to several embodiments, bulb separation distance “H” is approximately 5.25 inches (13.3 cm), and bulb clearance dimension “J” can be approximately 2.6 inches (6.6 cm). As previously discussed, the above dimensions are not limiting to the disclosure. For example, as few as one bulb 72 can be used and a maximum number of bulbs 72 can be determined by the manufacturer based on the size and envelope of cabinet 12. FIG. 8 depicts each of first doors 32, 32′ and second doors 52, 52′ in their fully closed positions having fasteners 38 releasably retaining first doors 32, 32′ in contact with first wall 28 and second wall 30 of cabinet 12, respectively. As evident, operation of any of fans 76 (only fans 76′ and 76′″ are show in this view) will initially direct flow of incoming air into an open space 77 between the doors.

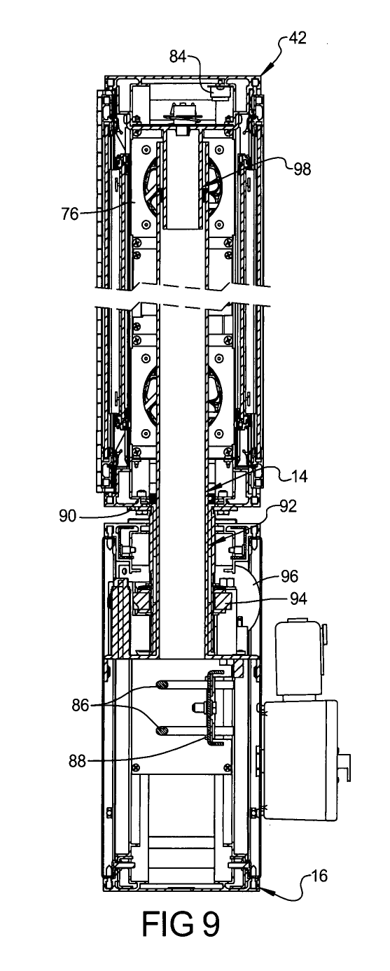

Referring now generally to FIG. 9, a thermostat 84 can be positioned proximate to upper wall 42. The temperature sensed by thermostat 84 generates a signal which controls operation of fans 76. According to several embodiments, fans 76 are energized when an internal cabinet temperature of approximately 100 degrees Fahrenheit is reached. Operation of fans 76 can produce a temperature reduction of approximately 20 degrees Fahrenheit for the air in cabinet 12. Operation of fans 76 therefore can delay or prevent heat load from operation of bulbs 72 and/or from solar gain from producing a temperature which can deform or damage the material of the sign inserts. For example, for an insert material such as styrene, a cabinet temperature of 160 degrees Fahrenheit or less is desirable to prevent onset of degradation of the styrene. Styrene begins to degrade at approximately 160 degrees Fahrenheit and can degrade very rapidly at a temperature of approximately 180 degrees Fahrenheit. Degradation of the sign insert can cause sagging or bowing which is visually undesirable, and can lead to damaged inserts. The approximate 20 degree Fahrenheit reduction in cabinet temperature from operation of fans 76 can therefore extend the operating life of the sign inserts. A second temperature set point can also be pre-determined for thermostat 84. The second temperature set point can be a low set point below which operation of any of fans 76 is terminated.

In several embodiments, support post 14 can be fixedly supported within mechanism cabinet 16 using at least one U-bolt 86 which is fastened to a mounting bracket 88. The use of U-bolts 86 and mounting bracket 88 prevent rotation of support post 14. A support flange 90 is fastenably connected to lower wall 44 of cabinet 12. A drive sleeve 92 is connected to support flange 90. Drive sleeve 92 is in turn rotated using a gear assembly 94 driven by a drive unit 96 such as an electric motor. An upper support tube 98 can also be provided which is matingly received with respect to support post 14. Upper support tube 98 fixes a free end of support post 14 relative to cabinet 12.

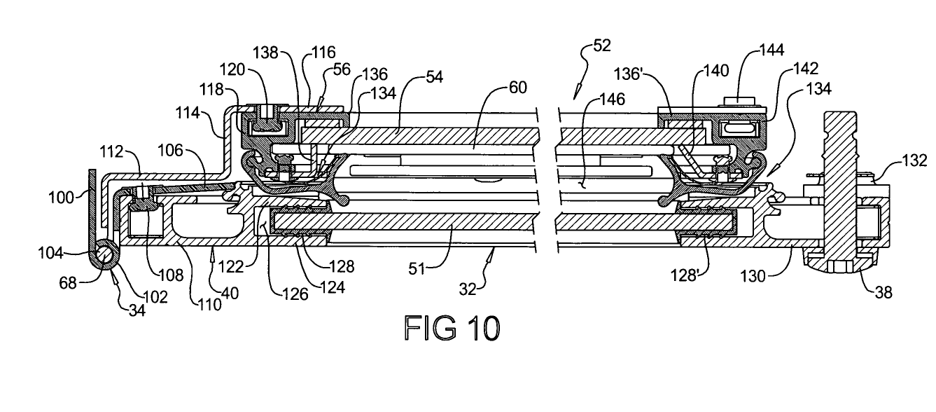

With reference now to FIG. 10, the structure of first hinge 34 and first and second doors 32 and 52 are shown. The construction of second hinge 36 and doors 32′, 52′ are substantially the same and will therefore not be further discussed. First hinge 34 includes a bracket or hinge mount leaf 100 which is connected for example using fasteners (not shown) or welded to first wall 28 of cabinet 12. A hinge pin retainer portion 102 is curved about the perimeter of a hinge pin 104 which is rotatably received within hinge pin retainer portion 102. A first door L-shaped hinge leaf 106 is further supported by hinge pin 104. L-shaped hinge leaf 106 is fixed using a fastener 108 such as a rivet to a first vertical frame element 110 of first door 32. A second door double L-shaped hinge leaf 112 is also rotatably supported by hinge pin 104. Second door double L-shaped hinge leaf 112 includes a second L-shaped hinge leaf 114 having a distal or free leg 116. Leg 116 is fixed to a first vertical frame member 118 of second door 52 using a fastener 120 such as a rivet.

First door frame 40 further includes a first rib 122 and an opposed second rib 124 which together define a panel receiving cavity 126. A ribbed engagement member 128 is inserted over an edge of first door panel 51, and ribbed engagement member 128 is thereafter received within panel receiving cavity 126. The outwardly extending ribs of ribbed engagement member 128 help retain the connection between first door frame 40 and first door panel 51. Material for ribbed engagement member 128 can be a resilient material such as an elastomeric rubber. A similar ribbed engagement member 128′ is oppositely positioned above first door panel 51 to similarly engage a second vertical frame element 130 of first door 32. It is noted that first vertical frame element 110 and second vertical frame element 130 can be a metal extrusion (e.g.: aluminum) or can also be an extruded polymeric material. A fastener retaining device 132 is also connected to second vertical frame element 130. One purpose for fastener retaining device 132 is to rotatably and yet non-releasably engage fastener 38 so that fastener 38 can be rotated to engage first door 32 in the fully closed position, or oppositely rotated to release first door 32 for rotation about first hinge 34.

Second door 52 includes an insert retainer 134 connected to each of first and second vertical frame members 118, 142. The design and operation of the insert retainers 134 are described in U.S. Pat. No. 4,145,828 to Hillstrom, commonly owned by the assignee of the present disclosure, the subject matter of which is incorporated herein by reference. A first panel retention arm 136, 136′ extends from each of first and second vertical frame members 118, 142. First panel retention arms 136, 136′ provide support on a first side of second door panel 54. A second panel retention arm 138 is further provided with first vertical frame member 118 and is fastenably connected thereto. Similarly, a panel retention arm 140 is fastenably connected to second vertical frame member 142. Second panel retention arm 138 and panel retention arm 140 together support a second face or side of second door panel 54. In several embodiments, a magnetic strip 144 can also be provided with second vertical frame member 142. Magnetic strip 144 provides releasable engagement between second door 52 and cabinet 12 to releasably retain second door 52 in the closed position. Magnetic strip 144 can also be provided with cabinet 12 in a location corresponding to that shown in FIG. 10 to engage second door 52.

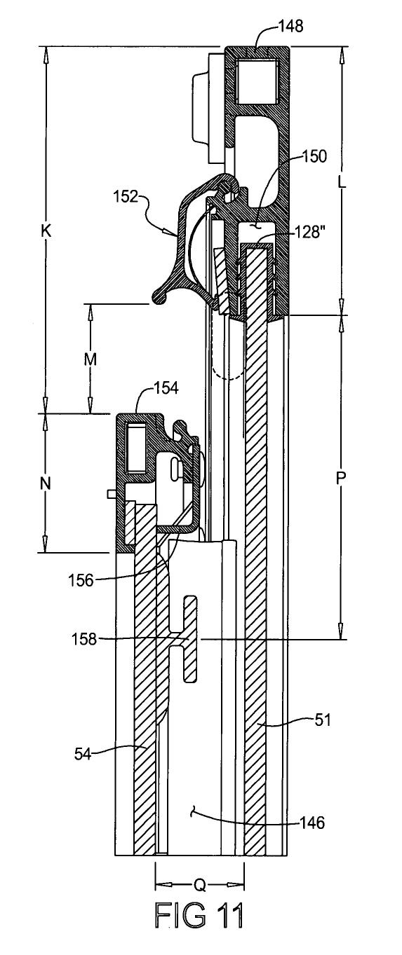

As shown in FIGS. 10 and 11, a clearance space or air flow gap 146 is maintained between first door panel 51 and second door panel 54. Air that is drawn into cabinet 12 by fans 76 and circulates within open space 77 is forced into air flow gap 146 for discharge out of cabinet 12. This maintains a constant air flow between first and second doors 32, 52 to maintain a cooling flow over the sign inserts attached to second door 52 when fans 76 are operating.

Referring now to FIG. 11, first door frame 40 further includes horizontal frame elements that connect to the vertical frame elements. A first door horizontal frame element 148 which is formed similar to the vertical frame elements provides a panel receiving cavity 150 similar to panel receiving cavities 126. A ribbed engagement member 128″ engages a corresponding edge of first door panel 51 to retain first door panel 51 in engagement with first door horizontal frame element 148. At least one releasable insert retainer 152 is also provided with first door horizontal frame element 148. The insert retainers 152 are similar in design to releasable insert retainers 134 previously discussed. Similar to first door horizontal frame element 148, a second door horizontal frame element 154 is provided for second door panel 54. An upper panel retention arm 156 fastenably engaged to secondary horizontal frame element 154 helps retain second door panel 54. An exemplary divider member identified as divider member 158 is shown in one of the plurality of installed positions.

According to several embodiments, a door height separation distance “K” is approximately 2.1 inches (5.3 cm), a horizontal frame height “L” is approximately 1.5 inches (3.8 cm), a clearance dimension “M” is approximately 0.6 inches (1.5 cm), and a horizontal frame height “N” is approximately 0.8 inches (2.0 cm). A separation distance “P” is approximately 1.8 inches (4.6 cm) which provides a masking area of first door 32. An air gap width “Q” of air flow gap 146 is approximately 0.5 inches (1.3 cm). Again as previously noted herein, the above dimensions are provided as exemplary dimensions only and can vary with the discretion of the manufacturer.

With reference now to FIGS. 12 and 12A, an exemplary installation of proximate ones of the divider members 58, 58′ shown in FIG. 3 is shown in greater detail. Each of the divider members 58 is constructed of a semi-transparent or translucent material having opposed flanges separated by a web. In the example shown, a first flange 160 is narrower than an inward facing second flange 162, so second flange 162 provides greater surface area in contact with first door panel 51. Second flange 162 also provides rear support for a sign insert such as sign insert 60 while allowing background light to diffuse through second flange 162. An outward facing side of first flange 160 defines a visual separation line between sign inserts and can be covered by a substantially opaque material such as an adhesive tape, an opaque pigmented paint, or the like. Outward facing first flanges 160 therefore provide a visual demarcation between the individual ones of the sign inserts when viewed from the outside of cabinet 12. As most clearly seen in FIG. 12A, a sign insert receiving cavity 164 is defined between first and second flanges 160, 162 and a center web 166 which separates first and second flanges 160, 162, to receive a sign insert.

Each of the insert retainers 134 previously described includes a leg 169 which when the insert retainer 134 is rotated to an open or disengaged position with respect to a sign insert are represented by exemplary legs 169′, 169″. An exemplary leg 169′″ is shown rotated to a closed or engaged position with a sign insert. Several legs 169 are not shown in FIG. 12 for clarity to provide better visibility of second panel retention arm 138 and panel retention arm 140. Each of the divider members 58, 58′ are installed by initially rotating legs 169 to the open or disengaged position, inserting a first extending portion 168 into one of a plurality of receiving apertures 170 created in second panel retention arm 138. After flexing the divider member at its approximate mid-span position an identical, opposing second extending portion 172 is releasably inserted in one of a plurality of second receiving apertures 174 (not visible in this view) created in panel retention arm 140. Directly opposed ones of first receiving aperture 170 and second receiving aperture 174 define pairs of receiving apertures. Multiple additional pairs of receiving apertures are similarly provided.

A minimum divider separation distance “R” is provided between any successive ones of the receiving apertures, such as between exemplary receiving apertures 170′, 170″. Divider separation distance “R” can vary at the discretion of the manufacturer to suit the requirements for a minimum width or size of a sign insert. Additional sign inserts such as sign insert 60′ or 65 (shown in FIG. 3) can be sized in multiple increments of the divider separation distance “R”. As best seen in FIG. 12A, a separation distance “AA” is provided between an end of first flange 160 and second flange 162. Separation distance “AA” provides clearance for leg 169 to rotate into contact with one of the sign inserts to temporarily restrain an outer edge of the sign inserts.

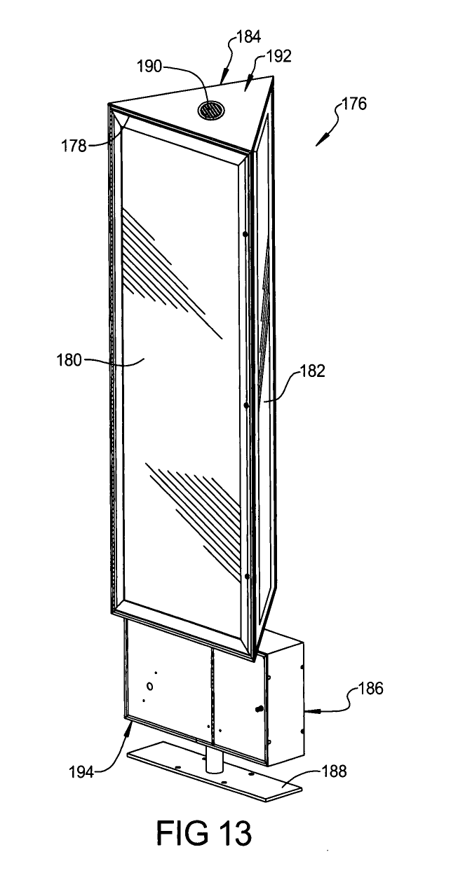

Referring to FIG. 13, according to further embodiments of the present disclosure a display device 176 includes a 3-sided cabinet 178. Each of the sides of 3-sided cabinet 178 is provided with a first double door assembly 180, a second double door assembly 182, or a third double door assembly 184. Each of the first, second and third double door assemblies 180, 182, 184 is similar to the design of first door 32 and second door 52. A mechanism cabinet 186 similar to mechanism cabinet 16 is provided to rotate 3-sided cabinet 178. An anchor device 188 is provided to support display device 176 from a ground or floor surface. Similar to display device 10, at least one air intake port 190 can be provided in 3-sided cabinet 178. Because of the close proximity of each of the double door assemblies 180, 182, 184, 3-sided cabinet 178 can have air intake port 190 provided in an upper surface 192. Additional air intake ports can also be provided in upper surface 192 or further provided in lower surface 194 which is not clearly visible in FIG. 13. It is anticipated that a reduced quantity of air intake ports 190 can be used for display device 176 because a larger interior volume is provided and as will be discussed further herein, a reduced number of bulbs can be used.

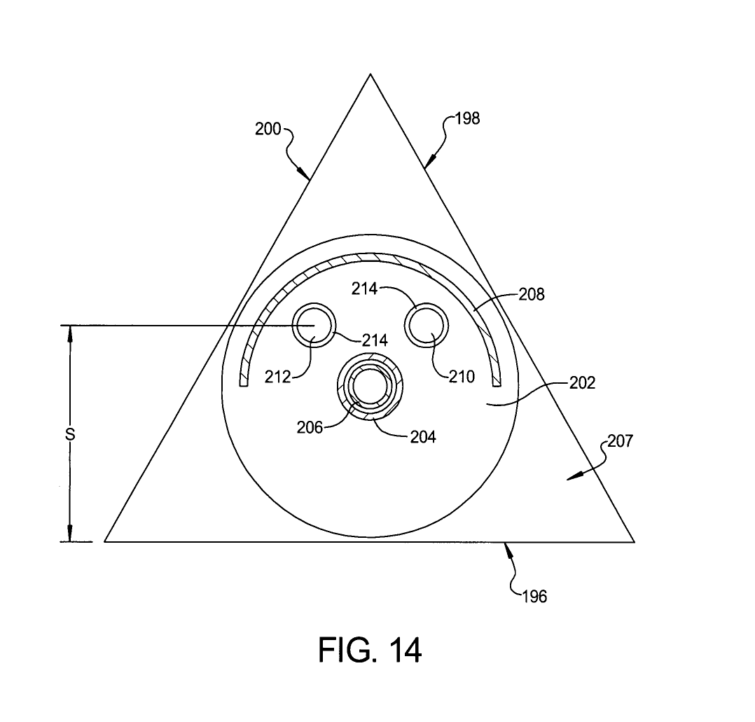

Referring finally now to FIG. 14, an exemplary first side 196, second side 198, and third side 200 of 3-sided cabinet 178 are identified. A non-rotatable plate 202 is positioned within 3-sided cabinet 178. Non-rotatable plate 202 can be non-rotatably connected to mechanism cabinet 186 using a support tube 204. A rotating support tube 206 can be provided for example within the inner diameter of support tube 204 and fixedly connected to a bottom wall 207 of 3-sided cabinet 178. Rotation of support tube 206 can therefore rotate bottom wall 207 and the corresponding first, second, and double door assemblies 180, 182, 184, while non-rotatable plate 202 remains stationary with respect to mechanism cabinet 186. This allows one of the first, second, or third sides 196, 198, 200 to be oriented toward a viewer. Each of the first, second, or third sides 196, 198, 200 can also be provided with a different theme similar to the themes for the 2-sided display device 10.

A light shield 208 of substantially semi-circular shape is fixed to non-locatable plate 202. At least one and in the embodiment shown a pair of bulbs including a first bulb 210 and a second bulb 212 are each connected to a socket 214, 214′ similar to sockets 74. Each of the sockets 214 and therefore each of bulbs 210, 212 are positioned within the curvature of light shield 208 to minimize light transfer toward two of the three sides of 3-sided cabinet 178. For example, in the arrangement shown light from bulbs 210, 212 will illuminate the double door assembly associated with first side 196 while second and third sides 198, 200 will be substantially non-illuminated. Display devices 176 can operate with a reduced quantity of bulbs 210, 212 compared to display device 10 because a bulb spacing “S” between the bulbs and the illuminated side is greater than a corresponding spacing between the bulbs 72 and the first or second display sides 24, 26 of display device 10. Increased bulb spacing “S” permits better light diffusion before the light reaches the second or inner door, and therefore permits the number of bulbs to be reduced. In further embodiments, light shield 208 can also be provided with a reflective inner surface to further enhance the illumination provided by the bulbs.

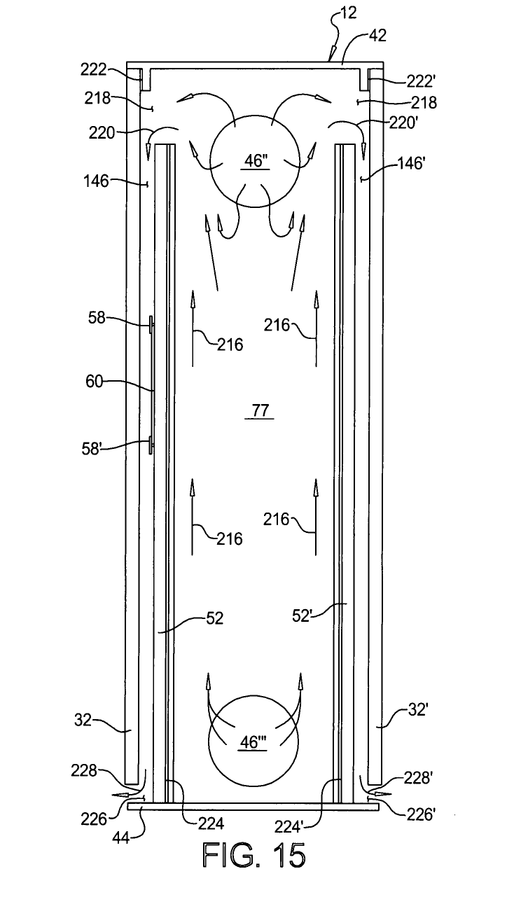

Referring to FIG. 15, representative air flow paths through the two-sided display device 10 of FIG. 1 are presented. Air enters cabinet 12 through each of the air intake ports 46, which in this view are represented by air intake ports 46″ and 46′″. Air flow in cavity or open space 77 is generally upwardly directed as shown by the various air flow direction arrows 216. At the two spaces 218, 218′ created between the upper ends of second doors 52, 52′ and upper wall 42, the volume of air is split and is redirected as shown by flow arrows 220, 220′ to flow downwardly into gap 146 created between first and second doors 32, 52 and into gap 146′ between first and second doors 32′, 52′. A first seal 222, 222′ located between first doors 32, 32′, respectively, and upper wall 42 prevents the positive air pressure within open space 77 from forcing air to be discharged at this interface. The flow of air through air flow gaps 146, 146′ cools the various sign inserts supported by second doors 52, 52′, here represented by first sign insert 60 supported by divider members 58, 58′. Second doors 52, 52′ substantially abut lower wall 44 of cabinet 12, and are sealingly engaged with wall structure of cabinet 12 using second seals 224, 224′ similar to first seals 222, 222′. A discharge air gap 226, 226′ is created between a lower end of first doors 32, 32′ and lower wall 44. The higher pressure air within gaps 146, 146′ is forced outward through discharge air gaps 226, 226′ in the direction of flow arrows 228, 228′, respectively, and discharged to the atmosphere.

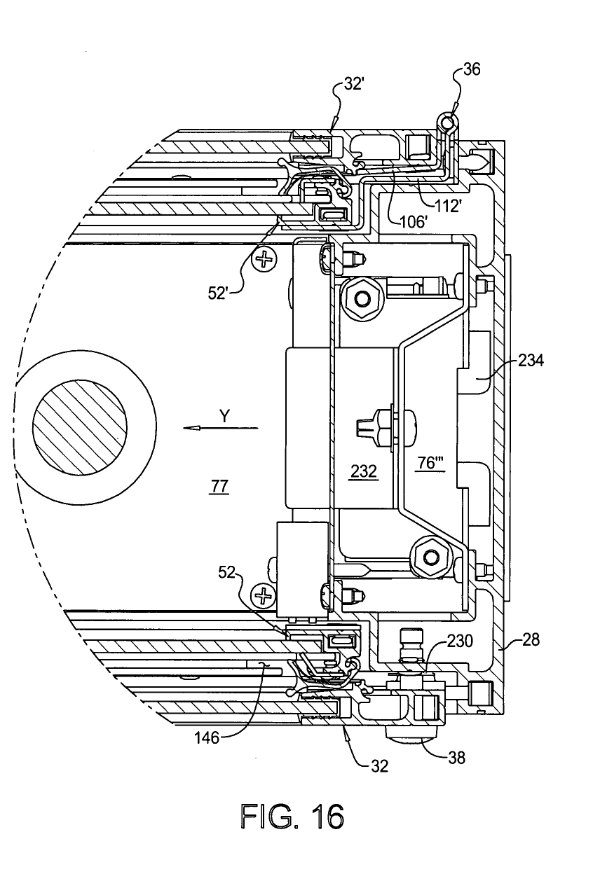

With reference to FIG. 16, when first and second doors 32, 52 are in the door closed position, first door 32 includes a door seal 230 which contacts structure of first wall 28. Door seal 230 helps provide an air seal to prevent air discharge past the first door 32 and cabinet 12 interface, which therefore helps retain the net positive pressure within cabinet 12. A similar door seal is also provided for first door 32′. Also, L-shaped hinge leaf 106′ and double L-shaped hinge leaf 112′ of second door 52′ can rotate separate from each other, or into an overlapped position (shown) which permits both first door 32′ and second door 52′ to co-rotate or individually rotate with respect to second hinge 36, and to reach the door closed position with the doors positioned substantially parallel to each other. The orientation of first door 32, second door 52, and first hinge 34 are identical. An exemplary set of fan blades 234 and a motor 232 for fan 76′″ are also shown.

A menu board assembly of the present disclosure offers several advantages. By adding a second, inner door the sign inserts are positioned on a surface which is not exposed to the elements and which can be accessed with the second door in the closed position which helps reduce motion of the door for example by wind load when the sign inserts are being installed or removed. A double hinge permits both first and second doors to share a common axis of rotation, which reduces the overall door assembly depth and therefore the depth of the cabinet. Fans oriented to provide for suction draw only and use of air gaps instead of discharge ports together create a positive air pressure in the cabinet which helps distribute cooling air evenly. Use of a translucent or semi-transparent material for the second or inner door panel promotes light diffusion to better backlight the sign inserts. Use of the double door concept on each side or face of the cabinet together with a rotation device allows different themes to be shown on each side.

What is claimed is:

1. An illuminated display device, comprising:
a housing having at least one illumination lamp positioned in the housing, and at least one display side including:
an outer first door rotatably connected to the housing, the first door having a substantially clear panel; and
an inner second door rotatably connected to the housing and positioned between the first door and the illumination lamp in a door closed position, the second door adapted to temporarily retain a sign back-illuminated by the lamp and visible through the clear panel.

2. The display device of claim 1, further comprising at least a second display side opposing the first display side, the second display side having a second one of the outer first door and a second one of the inner second door.

3. The display device of claim 2, further comprising at least one fan connected to the housing operable to only draw atmospheric air from outside the housing into the housing to create a positive air pressure at least between the first and second doors.

4. The display device of claim 3, further comprising a flow channel between a frame of the first door and a frame of the second door operable to permit the air at the positive air pressure to discharge to atmosphere.

5. The display device of claim 4, further comprising a plurality of incrementally spaced slots created in opposed relationship in opposed members of the second door frame adapted to releasably receive individual ones of a plurality of divider members, proximate ones of the divider members adapted to releasably retain a sign insert, the sign insert illuminated by the lamp and visible through both the first and second doors in the door closed position.

6. The display device of claim 5, wherein the divider members each further comprise a darkened outward facing portion and a translucent interior housing facing portion.

7. The display device of claim 3, further comprising a thermostat operable to control operation of the at least one fan when a predetermined temperature is sensed.

8. The display device of claim 7, wherein the sign insert includes a styrene material.

9. The display device of claim 1, further comprising a hinge operable to connect both the first and second doors to the housing and operable to permit individual rotation of both the first and second doors about a common rotation axis.

10. The display device of claim 2, wherein the housing defines a substantially rectangular shape further including opposed first and second side walls.

11. The display device of claim 2, wherein the housing is rotatable by an angular increment determined by a quantity of the display sides.

12. The display device of claim 1, wherein the housing defines a substantially triangular shape having first, second, and third display sides each including one each of the first and second doors.

13. The display device of claim 1, wherein the second door comprises a translucent panel supported by a frame.

14. A menu board illuminated display device, comprising:
a cabinet containing at least one illumination lamp, and having at least first and second display sides, each of the display sides including:
a first door rotatably connected to the cabinet on one of the first and second display sides; and
a second door rotatably connected to the cabinet and sharing a common axis of rotation with the first door, the second door positioned between the first door and the illumination lamp when both the first and second doors are oriented in a door closed position; and
a door frame of the second door having opposed frame members each including a plurality of incrementally spaced slots positioned as opposed pairs of slots, the opposed pairs of slots adapted to releasably receive individual ones of a plurality of divider members, proximate ones of the divider members adapted to releasably retain a sign insert, the sign insert illuminated by the lamp and visible through the first door in the door closed position.

15. The display device of claim 14, wherein the cabinet is rotatable about an axis in increments of one hundred eighty degrees to orient one of the first and second doors for viewing.

16. The display device of claim 15, wherein the first door includes:
a first door frame; and
a substantially clear panel supported by the first door frame.

17. The display device of claim 16, wherein the second door includes a substantially translucent panel supported by the second door frame, the sign insert mountable on an outward facing side of the translucent panel to be visible through the clear panel of the first door when the lamp is energized.

18. The display device of claim 14, further comprising a magnetic catch assembly operable to releasably retain the second door in the door closed position.

19. A menu board display device, comprising:
a first door having a substantially clear panel;
a hinge connected to the first door;
a second door rotatably connected by the hinge to the first door, the second door positioned substantially parallel to the first door in a door closed position; and
at least one sign insert releasably supported by the second door and visible through the clear panel in the door closed position.

20. The display device of claim 19, further comprising:
a second door panel connected to the second door; and
a door frame of the second door having opposed frame members each including a plurality of incrementally spaced slots positioned as opposed pairs of slots, each pair of slots adapted to releasably receive a divider member adapted to releasably retain one of the at least one sign inserts in abutment against the second door panel.

21. The display device of claim 19, further comprising a hinge pin of the hinge defining a common axis of rotation of the first and second doors.

22. A menu board illuminated display device, comprising:
a cabinet containing at least one illumination lamp, and having at least first and second sides, each of the sides including:
a hinge connected to the cabinet;
a first door rotatably connected to the cabinet using the hinge; and
a second door rotatably connected by the hinge to the cabinet and sharing a common axis of rotation with the first door, the second door positioned between the first door and the illumination lamp when both the first and second doors are oriented in a door closed position.

23. The display device of claim 22, further comprising a door frame of the second door having opposed frame members each including a plurality of incrementally spaced slots positioned as opposed pairs of slots.

24. The display device of claim 23, wherein the opposed pairs of slots are adapted to releasably receive individual ones of a plurality of divider members, proximate ones of the divider members adapted to releasably retain a sign insert, the sign insert illuminated by the lamp and visible through the first door in the door closed position.

25. The display device of claim 24, further comprising a side wall of the cabinet having a panel defining a pocket adapted to receive and store at least one of the divider members.

26. The display device of claim 24, wherein each of the divider members comprises:
a first flange adapted to be non-light transmissive;
an opposed second flange being wider that the first flange and substantially translucent; and
a web transversely positioned between the first and second flanges operable to create a cavity between the first and second flanges adapted to receive a portion of the sign insert.

27. The display device of claim 26, wherein the second flange is positioned facing toward the illumination lamp such that light from the illumination lamp is diffused through the second flange.

28. An illuminated display device, comprising:
a cabinet having at least one illumination lamp positioned in the cabinet, and at least one display face including:
an outer first door rotatably connected to the cabinet; and
an inner second door rotatably connected to the cabinet and positioned between the first door and the illumination lamp in a door closed position, the second door adapted to temporarily retain a sign back-illuminated by the lamp; and
at least one fan connected to the cabinet operable to draw atmospheric air into the cabinet to create a positive air pressure at least between the first and second doors.

29. The display device of claim 28, further comprising a substantially clear panel retained by a frame of the first door, the sign being visible through the clear panel with both first and second doors in the door closed position.

30. The display device of claim 28, further comprising a hinge operable to rotatably support both the first and second doors on a common axis of rotation.

31. The display device of claim 29, wherein the second door includes a translucent panel supported by a second door frame, the sign mountable on an outward facing side of the translucent panel to be visible through the clear panel of the first door when the lamp is energized.

32. A method for displaying sign inserts with an illuminated display device, the device including a cabinet having at least one display side including a first door having a substantially clear panel, the first door rotatably connected to the cabinet, and a second door rotatably connected to the cabinet and positioned between the first door and an interior space of the cabinet, the method comprising:
releasably connecting at least one divider member to the second door;
supporting a sign insert by the at least one divider; and
positioning at least one illumination lamp in the interior space of the cabinet such that illumination of the lamp back-illuminates the sign insert for visibility through the clear panel of the first door.

33. The method of claim 32, further comprising operating a fan connected to the cabinet to induce ambient temperature air to flow from outside the cabinet through the cabinet to reduce an interior temperature of the cabinet.

34. The method of claim 33, further comprising creating a gap between the first door and the second door with both the first and second doors in a door closed position, the gap operable as an exit flow path for the air from the cabinet.

35. The method of claim 34, further comprising predetermining a dimension of the gap to maintain a positive air pressure within the cabinet during operation of the fan.

36. The method of claim 32, further comprising mounting both the first and second doors on a common rotational axis defined by a hinge.

37. The method of claim 36, further comprising releasably engaging the first and second doors individually to the cabinet to permit opening the first door with the second door remaining in a closed position for access to the sign insert and to permit opening both the first and second doors for access to the lamp.

38. The method of claim 32, further comprising inserting a substantially translucent panel in the second door operable to partially diffuse light from the lamp.
